(19) United States
(12) Patent Application Publication
(10) Pub. No.: US 2017/0181454 A1
(43) Pub. Date: Jun. 29, 2017

(54) FLAVOUR COMPOSITION

(71) Applicant: Givaudan S.A., Vernier (CH)

(72) Inventors: Aloysius Lambertus DOORN, Zeewolde (NL); Giuseppe CORDA, Baarn (NL); Frans WITTEVEEN, Leusden (NL); David SIEGEL, Liberty Township, OH (US)

(21) Appl. No.: 15/313,360

(22) PCT Filed: Jun. 2, 2015
(86) PCT No.: PCT/EP2015/062261

§ 371 Date: Nov. 22, 2016

Related U.S. Application Data
(60) Provisional application No. 62/006,329, filed on Jun. 2, 2014.

(51) Int. Cl. A23L 2/68; A23L 33/10; A23L 27/00; A23L 2/56; A23L 27/12

(52) U.S. Cl. CPC A23L 2/68; A23L 2/56; A23L 27/12; A23L 27/13; A23L 27/72; A23L 27/82; A23L 33/10; A23V 2002/00

(57) ABSTRACT

A storage-stable, flavour composition, wherein said composition comprises a plurality of particles dispersed in a non-aqueous dispersing medium, said particles consisting of a first particle population of encapsulated flavour oil, and a second particle population of micronized acidulant particles.

The present invention is concerned with storage stable flavour compositions, more particularly citrus flavour compositions, and with food products or beverages containing said compositions.

Natural flavour ingredients have numerous uses in food and beverage products. Citrus oils are natural flavour ingredients with high consumer acceptance. Citrus oils are commonly added to foods and beverages in the form of emulsions. Unfortunately, certain flavour components in citrus oil emulsions, principally citral and limonene, are chemically unstable and are susceptible to rapid degradation at low pH, resulting in loss of flavour quality and a decrease in shelf life. This is a particularly difficult problem, as many flavour compositions commonly employ acidulants, such as citric acid, malic acid, succinic acid, acetic acid, fumaric acid and phosphoric acid.

A need therefore exists for a method of improving the stability and shelf life of flavour compositions, particularly citral- and/or limonene-containing flavour compositions, and food or beverage products containing same.

The present invention addresses this unmet need and provides in a first aspect a storage-stable, flavour composition, more particularly a citrus-flavour compositions, and still more particularly a flavour composition containing citral and/or limonene, wherein said composition comprises a plurality of particles dispersed in a dispersing medium, and more particularly a non-aqueous dispersing medium, said particles consisting of a first particle population of encapsulated flavour oil, and a second particle population of micronized acidulant particles, and said dispersing medium consisting of an organic solvent selected from the group consisting of triacetin, propylene glycol, Triethyl Citrate or glycerin; a dispersing agent; and a viscosifying agent soluble in said organic solvent; wherein the viscosity of the composition is sufficient to keep the particles dispersed. The preferred viscosity for the dispersion is between 0.05 Pa·s and 10 Pa·s.

In accordance with the present invention, the stability of the flavour composition derives from the combination of features whereby the flavour encapsulating medium protects the flavour oil by preventing its leakage into the dispersing medium, as well as the physical separation of the acidulant particles and the flavour-containing encapsulating medium.

The encapsulating medium may be selected from any encapsulation medium known in the art for encapsulating flavours for use in food products and beverages. In particular, the encapsulating medium may be provided in the form of core-shell microcapsules, wherein a liquid or solid core containing a flavour oil is completely or partially surrounded by a shell of polymeric material. Suitable shell-forming materials will include any food-grade materials that can form shells around solid particles or oil droplets by techniques such as interfacial polymerization or coacervation, for example gelatin, alginates or cellulosic materials.

Alternatively, the encapsulating medium may be in the form of particles of a matrix material in which is embedded the flavour oil. Such particles may be formed by any convenient technique, including spray drying, fluid bed drying or extrusion. Particularly suitable examples of encapsulating matrices are disclosed in EP 1 064 856 and EP 1 753 307, both of which documents are herein incorporated by reference in their entirety.

A typical process of forming particles of matrix material encapsulating flavour oil proceeds in a first step by forming an oil-in-water emulsion, whereby the dispersed phase contains the flavour oil, and the matrix forming materials are dissolved in the aqueous external phase. The emulsion can be prepared according to standard preparation procedures. Briefly, the practice involves dispersing and dissolving the matrix-forming materials in solvent until free of lumps. It may be desirable to warm the water prior to adding the matrix-forming material to aid dispersion and solubilization. The flavour oil is then added under constant agitation until a homogeneous mixture is obtained. The emulsion may be further subjected to high shear or homogenized to reduce oil droplet size prior to spray drying.

The flavour compositions of the present invention are prepared by dispersing equipment well known to persons skilled in the art. Induced shear forces should not result in breakup of the dispersed particles.

In certain embodiments, the emulsion contains between 0.5% and 70% by weight of flavour, including any solvent used to suspend the flavour and/or any other adjuvants that may be employed in the flavour oil. The amount of flavour and/or matrix material can be adjusted by using more or less water depending on the solubility of the matrix material and various factors related to efficient operation of the spray dryer. For example, the type and amount of matrix material, amount of water, and/or amount of flavour can be adjusted so that the resulting emulsion has a viscosity suitable for feeding into a spray dryer to provide liquid droplets having a desired volume weighted particle size. Moreover, the feed emulsion can be heated or cooled immediately before adding it to the spray dryer to modify fluidity. In addition, certain flavour ingredients, and particularly those that are relatively water-soluble, can act as plasticizers thereby making processing more difficult due to stickiness. In this respect, the amount of matrix-forming materials can be modified. Therefore, various factors can be appropriately selected or modified for use in combination with different spray dry apparatus.

The encapsulating media for the flavour oil should have a volume weighted particle size, such that particles can be suspended stably in the dispersing medium. In a particular embodiment of the invention, the encapsulating medium may have a volume weighted particle size (Dv) of about 10 to about 250 microns.

Particles of acidulant will tend to be denser than encapsulated flavour particles. As such, whereas the particles of acidulant may have a volume weighted particle size within the ranged referred to herein above, it may be preferable if the acidulant particles have a smaller volume weighted particle size than the encapsulated flavour particles, in order to ease the process of suspending both populations of particles in the dispersing medium. The skilled person will understand that micronisation of powders can be formed by well-known techniques in the art, such as milling and sieving, and it is not necessary to discuss these techniques in any greater detail here. The acidulant particles may consist entirely of acidulant, or they may contain contain excipients or carrier materials, which aid in the formation of said particles.

The physical separation of the particles of acidulant and the particles of encapsulated flavour is achieved by controlling the particle size of the particles, as described above, and through the selection of an appropriate dispersing medium for stably suspending the particles. The dispersing medium comprises an organic solvent selected from the group consisting of triacetin, propylene glycol, glycerol, triethyl citrate and ethanol.

The solvent should be substantially free of water. Furthermore, it should have a good solubility in water. In order to prevent creaming, sedimentation or coagulation of the particles, a viscosifying should be dissolved in the solvent. Suitable viscosifying agents should be soluble in the solvent in an amount to provide a composition have a viscosity high enough to keep the particles dispersed.

Suitable viscosifying agents include, but are not limited to, cellulose derivatives, and in particular methyl cellulose and poly sorbates.

The viscosifying agent may be present in the dispersing medium at a level high enough to keep the particles dispersed. The preferred viscosity for the dispersion is between 0.05 Pa·s and 10 Pa·s.

The dispersing medium additionally comprises a dispersing agent, such as an emulsifier or surfactant. The amount of dispersing agent employed in a composition according to the invention will depend upon a number of factors including the particle size of the particles to be suspended, and the viscosity of the dispersing medium, as well as the final application of the flavour composition. In a particular embodiment of the invention, the dispersing agent may be employed in amounts of up to about 10% by weight of the flavour composition.

Examples of suitable dispersing agents include, but are not limited to, lecithins, sucrose esters, polysorbates (e.g., polyoxyethylene sorbitan monolaurate, polyoxyethylene sorbitan monooleate, polyoxyethylene sorbitan monopalmitate, polyoxyethylene sorbitan monostearate, polyoxyethylene sorbitan tristearate), sorbitan esters, for example sorbitan laurate, sorbitan stearate and sorbitan oleate; proteins, gums, soap-bark extract, saponins, and the like.

The flavour employed in a flavour composition according to the present invention may be chosen from synthetic flavour and flavouring aromatics, and/or oils, oleo resins and oil extracts derived from plants, leaves, flowers, fruits, and combinations thereof. Representative flavour oils include, but are not limited to, spearmint oil, cinnamon oil, peppermint oil, clove oil, bay oil, thyme oil, cedar leaf oil, oil of nutmeg, oil of sage, and oil of bitter almonds. Also useful are artificial, natural or synthetic fruit flavours such as vanilla, chocolate, coffee, cocoa and citrus oil, including lemon, orange, grape, lime and grapefruit, and fruit essences including apple, pear, peach, strawberry, raspberry, cherry, plum, pineapple, apricot and so forth. These flavours can be used individually or in admixture.

In addition, a variety of volatile compounds may be contained in the flavour, including, but not limited to acetaldehyde, dimethyl sulfide, ethyl acetate, ethyl propionate, methyl butyrate, and ethyl butyrate. Flavours containing volatile aldehydes or esters include, e.g., cinnamyl acetate, cinnamaldehyde, citral, diethylacetal, dihydrocarvyl acetate, eugenyl formate, and p-methylanisole. Further examples of volatile compounds that may be present in the instant flavour oils include acetaldehyde (apple); benzaldehyde (cherry, almond); cinnamic aldehyde (cinnamon); citral, e.g. alpha citral (lemon, lime); neral, e.g. beta citral (lemon, lime); decanal (orange, lemon); ethyl vanillin (vanilla, cream); heliotropine, piperonal (vanilla, cream); vanillin (vanilla, cream); alpha-amyl cinnamaldehyde (spicy fruity flavours); butyraldehyde (butter, cheese); valeraldehyde (butter, cheese); citronellal (modifies, many types); decanal (citrus fruits); aldehyde C-8 (citrus fruits); aldehyde C-9 (citrus fruits); aldehyde C-12 (citrus fruits); 2-ethyl butyraldehyde (berry fruits); hexenal, trans-2 (berry fruits); tolyl aldehyde (cherry, almond); veratraldehyde (vanilla); 2,6-dimethyl-5-heptenal, i.e., melonal (melon); 2-6-dimethyloctanal (green fruit); and 2-dodecenal (citrus, mandarin); cherry; or grape; limonene, and mixtures thereof. The composition may contain other ingredients commonly employed in flavours, such as taste modulators, artificial sweeteners, masking agents, sweeteners and sweetness modifiers, colourants, preservatives, and the like.

Other flavour ingredients may be employed in a flavour composition according to the present invention, for example those materials described in in “Chemicals Used in Food Processing”, publication 1274, pages 63-258, by the National Academy of Sciences.

Examples of excipients and adjuvants commonly used in flavour compositions may be found in such publications as “Perfume and Flavour Materials of Natural Origin”, S. Arctander, Ed., Elizabeth, N.J., 1960; in “Perfume and Flavour Chemicals”, S. Arctander, Ed., Vol. I & II, Allured Publishing Corporation, Carol Stream, USA, 1994; in “Flavourings”, E. Ziegler and H. Ziegler (ed.), Wiley-VCH Weinheim, 1998, and “CTFA Cosmetic Ingredient Handbook”, J. M. Nikitakis (ed.), 1st ed., The Cosmetic, Toiletry and Fragrance Association, Inc., Washington, 1988.

Other suitable and desirable ingredients of flavour compositions are described in standard texts, such as “Handbook of Industrial Chemical Additives”, ed. M. and I. Ash, 2nd Ed., (Synapse 2000).

The present invention also relates to a method for preparing storage-stable, flavour compositions as described herein above. The method of the invention comprises the step of providing a viscous non-aqueous dispersion of particles wherein particles of encapsulated flavour are physically separated from particles of acidulant by means of the viscous dispersing medium.

The present invention further relates to a method for improving the stability of a flavour composition comprising the step of providing a viscous non-aqueous dispersion of particles wherein particles of encapsulated flavour are physically separated from particles of acidulant by means of the viscous dispersing medium.

As used herein, “storage stable” means that the stability of the flavour composition is improved in the presence of the stabilizing agent relative to the stability of the flavour system without the stabilizing agent.

Flavour compositions of the present invention may be incorporated into all manner of food or beverage product. Beverages include, but are not limited to, flavoured water, soft drinks, fruit drinks, coffee-based drinks, tea-based drinks, juice-based drinks (includes fruit and vegetable), milk-based drinks, gel drinks, carbonated or non-carbonated drinks, powdered drinks, alcoholic or non-alcoholic drinks. However, the flavour composition may be stored in a suitable container and used as a finished article in its own right. In particular, the flavour composition of the present invention may be used as a water-enhancer. Water enhancers are known in the art and consist of a viscous liquid, which may be added to water to provide a flavour and optionally colour thereto.

Accordingly, in another aspect of the present invention there is provided a liquid water enhancer comprising a flavour composition as hereinabove described.

There now follows an example, which further serves to illustrate the invention.

### EXAMPLE1

A mixture of triacetin containing 2% Admul T60K was stirred until dissolved. A spray dried flavour, was dosed to the triacetin/Admul T60K mixture and stirred until homogeneously dispersed. The level of spray dried flavour added to the mix was 30% by weight. The citric acid was micronized to a size of 20 to 80 micron and stirred into the described dispersion at a level of 1% by weight.

The homogeneous odourless dispersion provides a fresh flavour profile when dosed into hot or cold water application. The dosage for this application was 1%.

1. A storage-stable, flavour composition, wherein said composition comprises a plurality of particles dispersed in a dispersing medium, said particles consisting of a first particle population of encapsulated flavour oil, and a second particle population of micronized acidulant particles, and said dispersing medium consisting of an organic solvent selected from the group consisting of triacetin, triethyl citrate, propylene glycol, glycerin or ethanol; a surfactant; and a viscosifying agent, soluble in said organic solvent.

2. The composition according to claim 1 wherein the flavour is a citrus flavour.

3. The composition according to claim 1 wherein the flavour contains citral and/or limonene.

4. The composition according to claim 1 wherein the solvent is triacetin, the viscosifying agent is methylcellulose, and the surfactant is a polysorbate.

5. A liquid water enhancer comprising a flavour composition as defined in claim 1.

6. A food or beverage comprising a flavour composition as defined in claim 1.

7. The food or beverage according to claim 6 wherein the flavour is a citrus flavour.

8. The food or beverage according to claim 6 wherein the flavour contains citral and/or limonene.

9. The food or beverage according to claim 6 wherein the solvent is triacetin, the viscosifying agent is methylcellulose, and the surfactant is a polysorbate.

10. The liquid water enhancer according to claim 5 wherein the flavour is a citrus flavour.

11. The liquid water enhancer according to claim 5 wherein the flavour contains citral and/or limonene.

12. The liquid water enhancer according to claim 5 wherein the solvent is triacetin, the viscosifying agent is methylcellulose, and the surfactant is a polysorbate.
